(19) United States
(12) Patent Application Publication
(10) Pub. No.: US 2006/0152334 A1
(43) Pub. Date: Jul. 13, 2006

(54) Electrostatic discharge protection for embedded components

(76) Inventors: Nathaniel Maercklein, Naperville, IL (US); Tushar Vyas, Streamwood, IL (US); Timothy Pachla, Berwyn, IL (US); Stephen Whitney, Lake Zurich, IL (US)

Correspondence Address: BELL, BOYD & LLOYD LLC, P. O. BOX 1135, CHICAGO, IL, 60690-1135, US

(21) Appl. No.: 11/032,442

(22) Filed: Jan. 10, 2005

(51) Int. Cl. H01C 3/06

(52) U.S. Cl. 338/210

(57) ABSTRACT

An improved electrical circuit that includes an embedded electrical component and an embedded voltage variable material (“VVM”) is provided. In one embodiment, the embedded VVM is provided as a voltage variable substrate, which is used in combination with an embedded electrical component, such as an embedded resistive material or an embedded capacitive material.

### CROSS-REFERENCE TO RELATED APPLICATIONS

This application is related to the following commonly-owned co-pending patent applications: U.S. patent application Ser. No. 10/958,442, filed Oct. 5, 2004, entitled “Direct Application Variable Material, Devices Employing Same And Methods Of Manufacturing Such Devices,” which claims priority as a continuation-in-part to U.S. patent application Ser. No. 10/746,020, filed Dec. 23, 2003, entitled “Direct Application Voltage Variable Material, Components Thereof And Devices Employing Same,” which claims priority as a continuation-in-part to U.S. patent application Ser. No. 10/410,393, filed Apr. 8, 2003, entitled “Voltage Variable Material For Direct Application And Devices Employing Same,” which claims priority of U.S. Provisional Patent Application No. 60/370,975, filed Apr. 8, 2002, entitled “Voltage Variable Material For Direct Application And Devices Employing Same,” and U.S. patent application Ser. No. 09/976,964, filed Oct. 11, 2001, entitled “Voltage Variable Substrate Material,” the entire contents of each of which are hereby incorporated by reference and relied upon.

### BACKGROUND OF THE INVENTION

The present invention relates to circuit protection. More particularly, the present invention relates to a voltage variable material (“VVM”).

Electrical overstress transients (“EOS transients”) produce high electric fields and high peak powers that can render circuits or the highly sensitive electrical components in the circuits, temporarily or permanently non-functional. EOS transients can include transient voltages or current conditions capable of interrupting circuit operation or destroying the circuit outright. EOS transients may arise, for example, from an electromagnetic pulse, an electrostatic discharge, lightning, a build-up of static electricity or be induced by the operation of other electronic or electrical components. An EOS transient can rise to its maximum amplitude in subnanosecond to microsecond times and have repeating amplitude peaks.

The peak amplitude of the electrostatic discharge transient wave (“ESD event”) may exceed 25,000 volts with currents of more than 100 Amperes. There exist several standards which define the waveform of the EOS transient. These include IEC 61000-4-2, ANSI guidelines on ESD (ANSI C63.16), DO-160, and FAA-20-136. There also exist military standards, such as MIL STD 883 part 3015.

Voltage variable materials (“VVM's”) exist for the protection against EOS transients, which are designed to rapidly respond (i.e., ideally before the transient wave reaches its peak) to reduce the transmitted voltage to a much lower value and clamp the voltage at the lower value for the duration of the EOS transient. VVM's are characterized by high electrical resistance values at low or normal operating voltages. In response to an EOS transient, the materials switch essentially instantaneously to a low electrical resistance state. When the ESD event has been mitigated these materials return to their high resistance state. The VVM's are capable of repeated switching between the high and low resistance states, allowing circuit protection against multiple ESD events.

VVM's also recover essentially instantaneously to their original high resistance value upon termination of the ESD event. For purposes of this application, the high resistance state will be referred to as a high impedance state and the low resistance state will be referred to as a low impedance state. EOS materials can withstand thousands of ESD events and recover to the high impedance state after providing protection from each of the individual ESD events.

Circuit components utilizing EOS materials can shunt a portion of the excessive voltage or current due to the EOS transient to ground, protecting the electrical circuit and its components. A major portion of the threat transient is reflected back towards the source of the threat. That reflected wave is either attenuated by the source, radiated away, or re-directed back to the surge protection device which responds with each return pulse until the threat energy is reduced to safe levels.

Given the above-described properties and advantages of VVM's, a need exists to continue to develop further applications and devices employing such VVM's.

### SUMMARY OF THE INVENTION

In one aspect of the present invention, electrical components such as resistors and capacitors are embedded with voltage variable material (“VVM”) in a printed circuit board (“PCB”), such as a multilayer PCB. In one implementation, the electrical components are provided as a material that is laminated onto an insulative substrate of the PCB or between two such substrates. The material for instance is a resistive material or a dielectric material. The dielectric material is contacted on each face by a conductive plate. The resistive material is contacted at each end by a lead or trace. The electrical materials can be applied over a relatively large area of the insulative substrate and used as needed within one or more electrical circuits provided on the PCB.

The VVM is also laminated to the insulative substrate, such as an opposite side of the substrate from which the electrical component film is laminated. The combination of the insulative substrate(s), component film and VVM can be provided as a device or as a PCB capable of receiving circuit traces, surface-mounted components, through-hole components and other items. The resulting VVM structure can have a surface area of any desired size, such as greater than one square inch. The electrical component film and the VVM layer are imbedded within the PCB, saving valuable space on the surface of the PCB and potentially reducing the overall size needed for the PCB. The embedded component film and VVM layer can also reduce cost and improve signal integrity. The VVM protects electrical components located in or on the PCB from an energy overload due to an ESD event.

As discussed below, the electrical components, VVM and insulative substrates can be arranged in many different ways to achieve a desired result. In general, each arrangement results in a parallel electrical relationship between the device to be protected, e.g., the resistive or capacitive material, and the VVM. In this manner, when no ESD event is present, the VVM exists in a high impedance state and current flows instead through the embedded electrical component(s) under a normal operation of the electrical circuit. When an ESD event occurs, the VVM switches to a low impedance state causing the ESD energy to dissipate through the VVM instead of the embedded electrical component, protecting such component from the harmful effects of the ESD energy.

As shown below, the VVM is placed in parallel with the embedded electrical component. The parallel electrical relationship may be maintained with the VVM embedded within the PCB or placed on top of the PCB. In certain applications, one or more vias or holes is provided in one or more layers of the PCB. The via(s) enables the embedded electrical component or the VVM to communicate electrically with conductors located on multiple layers of the PCB.

The VVM in an embodiment is placed in an X-Y or coplanar arrangement with its contacting electrodes. Here, the electrodes are positioned to create a VVM gap that extends at least substantially parallel to the plane of the electrodes. The VVM is placed in the gap, contacting the electrodes. The coplanar or X-Y gap is sized appropriately to shunt ESD energy to a desired conductor, such as a ground or shield conductor.

The VVM in another embodiment is placed in a Z-direction application with respect to the contacting electrodes. Here, electrodes are for example stacked one on top of the other and the VVM is placed between the electrodes. The VVM gap here is created by the thickness of the VVM layer. The thickness or gap size is again sized appropriately to shunt ESD energy to a desired conductor, such as a ground or shield conductor. The ESD energy is shunted around the component to be protected in one embodiment.

In another primary embodiment of the present invention, the VVM is applied as a layer to a conductive foil to form an active substrate or active laminate. The resulting active laminate may be partially cured and applied to a supporting substrate, such as a rigid PCB. In the present invention, the VVM layer is coated or applied to a conductive, e.g., copper, layer to produce the active substrate or laminate. The active substrate is used in combination with embedded electrical components in many different ways as shown in detail below. In an embodiment, the electrical components are also applied as a layer, e.g., laminated to the exposed side of the VVM layer of the active laminate. The active substrate conveniently replaces an otherwise necessary insulative layer. The active substrate also extends in multiple directions so that the substrate can protect multiple electrical components.

The active substrate provides each of the same benefits as the embedded VVM embodiments, such as conserved board space, reduced cost, etc. The active substrate is also an embedded VVM application, in which the VVM layer doubles as a normal voltage state insulating substrate.

The VVM layer can be placed in a parallel electrical arrangement with the embedded electrical component(s). The VVM layer may also form gaps in the X-Y or Z directional arrangements described above. The PCB employing the VVM layer and active substrate may include one or more vias that enable energy to be shunted to different conductive layers within the PCB. The PCB may include a plurality of VVM or active substrate layers, combine the VVM layer with one or more insulative substrates and protect a variety of different types of embedded electrical components.

Additional features and advantages of the present invention are described in, and will be apparent from, the following Detailed Description of the Invention and the figures.

### BRIEF DESCRIPTION OF THE FIGURES

FIG. 1 is a schematic electrical illustration of a voltage variable material (“VVM”) or a device using same.

FIG. 2 is a graph of voltage versus time illustrating the voltage clamping effects of the VVM of the present invention.

FIGS. 3A to 3C are schematic electrical illustrations of a VVM or a device using same placed in a parallel relationship with a resistor, capacitor and signal line, respectively.

FIG. 4 is a sectioned perspective view of a printed circuit board employing both the embedded component/VVM and the active substrate embodiments of the present invention.

FIGS. 5A, 5B, 6A, 6B, 7A and 7B are schematic electrical illustrations of an embedded resistor and an electrode pair forming a gap and various embodiments for embedding VVM in a parallel relationship with the resistor across the gap.

FIGS. 8 and 9 are schematic electrical illustrations of a resistor element placed in a parallel relationship with VVM, both of which are embedded between three insulative substrates.

FIG. 10 is a schematic electrical illustration of a resistor element placed in a parallel relationship with VVM, the element embedded between four insulative substrates, and the VVM placed in a via.

FIGS. 11 to 14 are schematic electrical illustrations of a capacitive dielectric element placed in a parallel relationship with VVM, the element embedded between two insulative substrates, and wherein at least one electrode is located outside of one of the substrates.

FIG. 15 is an elevation view of one embodiment of an active laminate (or resin coated foil) of the present invention that includes an insulative substrate embedded with VVM, which is coupled with a conductive layer.

FIG. 16 is an elevation view of an assembly that uses the active laminate of FIG. 15 and a coating of resistive material on the active laminate.

FIG. 17 is a plan view of an assembly, which uses the active laminate of FIG. 15, is coated with a resistive material and is provided with various electrodes.

FIG. 18 is a cross-sectional view of FIG. 17 taken along line XVIII-XVIII.

FIG. 19 is an elevation view of the active laminate of FIG. 15, which is coated with a capacitive dielectric material and provided with various electrodes and an additional insulative substrate or another active laminate.

FIG. 20 is a plan view of an application of the active laminate of FIG. 15 in combination with a plurality of data lines.

FIG. 21 is a cross-sectional view of FIG. 20 taken along line XXI-XXI.

### DETAILED DESCRIPTION OF THE INVENTION

### Overview

In one primary embodiment of the present invention, electrical components such as resistors and capacitors are embedded with voltage variable material (“VVM”) in a printed circuit board (“PCB”), such as a multilayer PCB. In one implementation, the electrical components are provided as a film that is laminated onto an insulative substrate of the PCB or between two such substrates. The VVM is also laminated to an insulative substrate, such as an opposite side of the substrate from which the electrical component film is laminated. The combination of the insulative substrate(s), component film and VVM can be provided as a device or as a PCB capable of receiving circuit traces, surface-mounted components, through-hole components and other items.

The embedded components and VVM reduces the overall size and cost of a resulting device or PCB. The embedded components and VVM also frees space on the outsides, e.g., top and bottom sides, of the PCB and improves signal integrity. The electrical, e.g., resistive or capacitive, films can be damaged by an electrostatic discharge (“ESD”) event even during normal handling of the PCB. The VVM protects those films and/or other components located on the PCB during such events.

In another primary embodiment of the present invention, VVM is impregnated into an epoxy or resin. The epoxy or resin is then applied to a conductive foil, such as a copper foil. The resulting structure is termed herein as an “active laminate” or “active substrate”. The resulting structure is also termed herein as a resin coated foil (“RCF”) or resin coated copper (“RCC”), wherein the resin or epoxy is impregnated with VVM particles, yielding an active RCF or RCC. In one embodiment, the epoxy or resin of the substrate is the insulative binder of the VVM.

The active substrate or active laminate is compatible with many secondary electronics or component assembly processes, even high-end, high density processes. The active substrate provides each of the same benefits as the embedded VVM, such as conserved board space, reduced cost, etc. The active substrate is also an imbedded VVM application, in which the VVM layer doubles as an insulating substrate under normal operation of the electrical circuit(s) protected by the VVM layer.

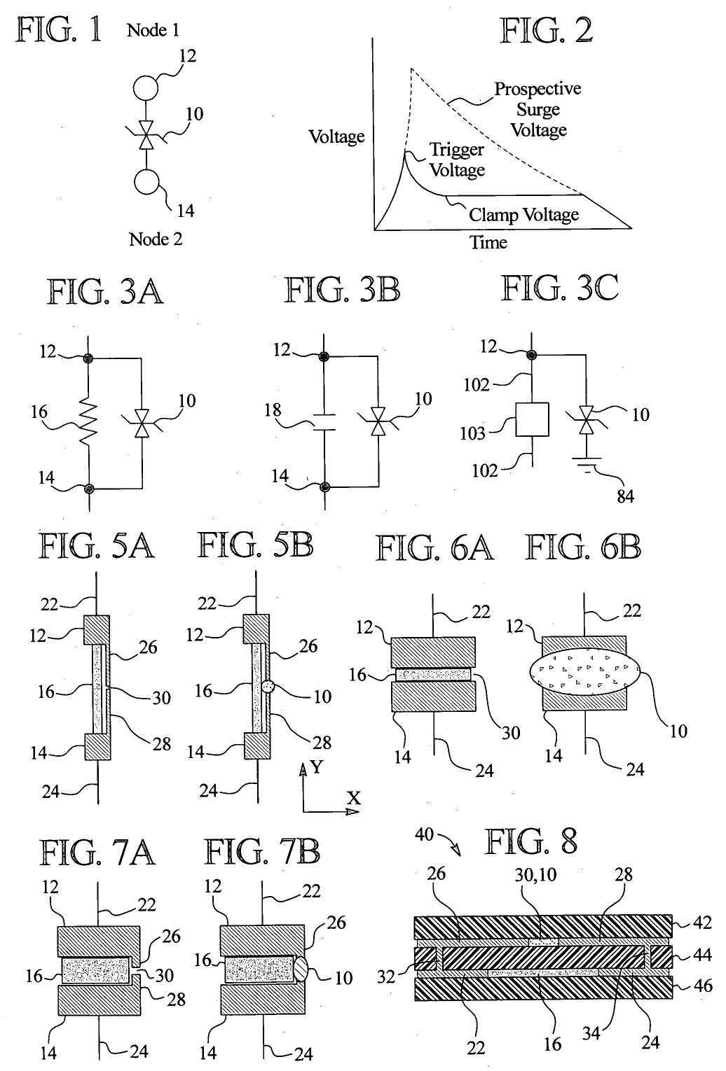

Referring now to the drawings and in particular to FIG. 1, VVM 10 of the present invention is connected electrically between nodes 12 and 14. VVM 10 is illustrated with a device symbol, however, VVM 10 in various embodiments shown below is applied as a layer on a substrate to a conductive film. VVM 10 is highly resistive, e.g., from about 1000 ohms to about 10¹² ohms, under normal conditions so that very little current flows between nodes 12 and 14. Upon an ESD event, VVM 10 becomes much more conductive, e.g., from about 0.1 ohms to about 100 ohms, allowing the ESD energy to move between nodes 12 and 14. In an embodiment, one of the nodes is grounded so that the ESD energy is shunted to ground. Alternatively, nodes 12 and 14 may be leads from an electrical component, such as a resistor or capacitor.

FIG. 2 shows that upon an ESD event beginning approximately at time t=0, the voltage across a circuit begins to increase rapidly. If no VVM is provided, the voltage quickly pulses to a maximum surge voltage, which may exceed the voltage rating of various electrical components within the circuit by orders of magnitudes. When VVM is provided, the VVM triggers or changes from a high impedance state to a low impedance state at the trigger voltage shown in FIG. 2. Afterward, the voltage due to the ESD event is clamped to a steady clamping voltage as seen in FIG. 2. The clamping voltage can be from about 5 volts to about 300 volts. Eventually, the voltage due to the ESD event tapers from the clamping voltage to zero.

FIGS. 3A and 3B illustrate how VVM 10 protects an electrical component, such as a resistor 16 (FIG. 3A) or a capacitor 18 (FIG. 3B). In an embodiment, VVM 10 is placed in parallel with the electrical component. When no ESD event is present, VVM 10 is in a high impedance state, forcing the majority of current through electrical component 16, 18. When an ESD event is present, VVM 10 switches from the high impedance state to the low impedance state, providing a path for the ESD energy to bypass electrical component 16, 18, protecting such component.

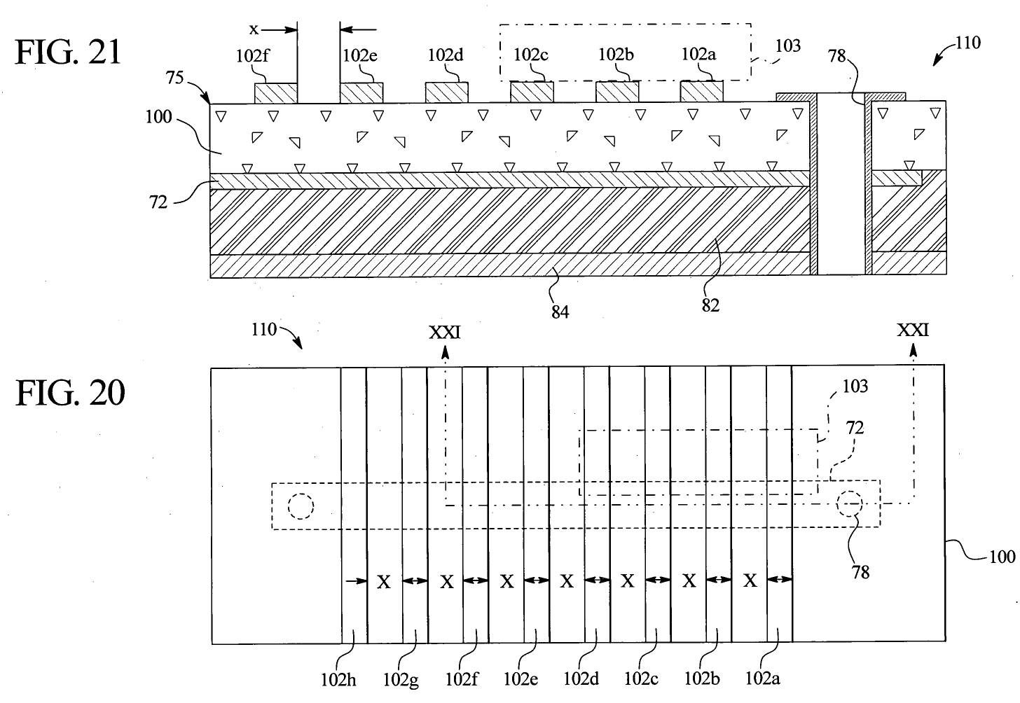

FIG. 3C illustrates how VVM 10 protects a signal trace or lead 102 or one or more electrical device 103 connected to lead 102. Here, VVM 10 is connected electrically between trace 102 and ground or shield 84. Another application involving signal leads 102 and a device 103 is discussed below in connection with FIGS. 20 and 21. As seen in FIG. 3C, when no ESD event is present, VVM 10 is in a high impedance state, forcing a majority of current through trace 102 and device 103. When an ESD event is present, VVM 10 switches from the high impedance state to a low impedance state, providing a path for the ESD energy to shunt to ground 84, protecting trace 102 and device 103. Device 103 can be any of the electrical devices discussed herein, including an integrated circuit.

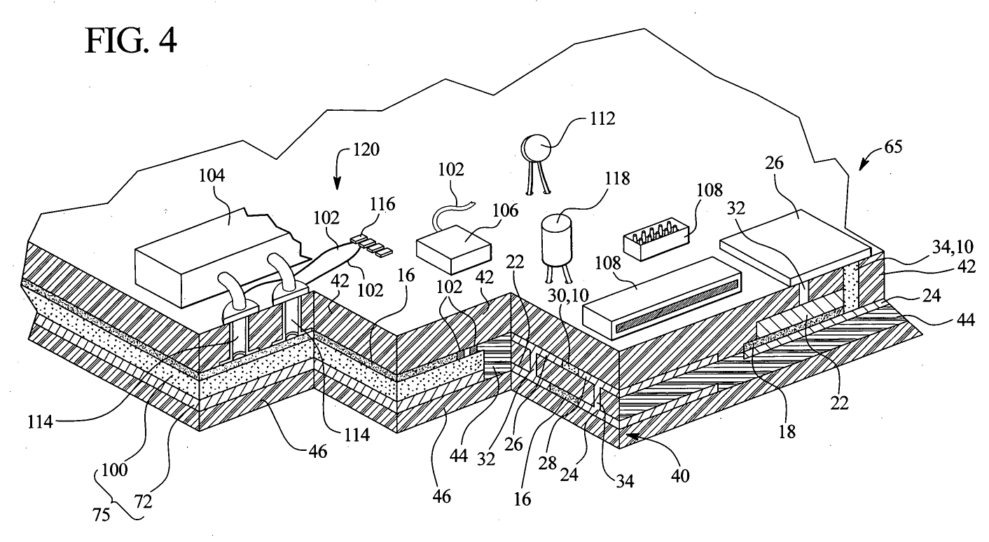

Referring now to FIG. 4, an application of the embedded VVM/components and active substrate embodiments of the present invention is illustrated via a PCB 120, which is a multilayer PCB populated with many different types of electrical components, such as resistors 116, capacitors 118 and circuit traces 102. PCB 120 is a completely assembled board, which may be placed in any type of electronic device, such as a computer, television, cell phone, communications device, digital recording device, etc. PCB 120 may be partially or fully assembled by an assembler, which contracts with an original equipment manufacturer (“OEM”) to produce a part or all of the board. The OEM generally performs final assembly, placing components onto PCB 120, such as integrated circuit (“IC”) chips 104, battery back-up chips 106, connectors 108, varistors 112, surface-mount resistors 116, surface-mount capacitors 118 and the like. PCB 120 also has traces 102 formed or etched on its surface.

PCB 120 is a multilayer board with three insulative layers 42, 44 and 46. In an embodiment the layers are relatively rigid, e.g., made of FR-4 material. In an alternative embodiment, the insulative layers can be semi-rigid, e.g., of a polyimide, such as Kapton™ tape. Insulative layers 42, 44 and 46 are sectioned to show the application of the embodiments described in more detail below.

Embedded assemblies 40 and 65 described in detail below are shown in FIG. 4 to provide an example of how such assemblies may be used in a finally assembled PCB, here PCB 120. PCB 120 is merely one example of many different types of end products that may employ the embodiments described herein.

Generally, resistor assembly 40 includes substrates 42, 44 and 46. Middle substrate 44 includes or defines vias 32 and 34. Vias 32 and 34 enable leads or traces 22 and 24 located between substrates 44 and 46 to communicate electrically with conductors 26 and 28 located between substrates 42 and 44. Leads or traces 22 and 24 communicate with each other electrically through resistive material 16. Conductors 26 and 28 are located between substrates 42 and 44. Conductors 26 and 28 and substrates 42 and 44 define a gap 30, which is filled VVM 10, so that the VVM contacts conductors 26 and 28. One of the conductors 26 and 28 may be or lead to a ground or shield.

The embedded resistive material 16 may replace some, many and potentially all of the surface mounted resistors 116 shown on the top surface of substrate 42 of PCB 120. Also, various traces 102 located on the top surface of PCB 120 that would otherwise lead to the replaced surface mounted resistors 116 could also be embedded between substrates 42, 44 and 46, like traces 22 and 24. Because resistive material 16 is embedded and not easily replaced, it is important to protect the material from the harmful effects of an ESD event. VVM 10 provides such protection. VVM 10 is likewise embedded and consumes no valuable external PCB space.

In an embodiment different areas of resistive material 16 having different resistivities are placed between substrates 42, 44 and 46. The different resistivities enable different circuits to employ different resistances as desired. Also, resistive material 16 can be applied in any desired shape, trace pattern and/or quantity as needed.

In general, embedded capacitor assembly 65 employs insulative substrates 42 and 44. Upper substrate 42 includes or defines vias 32 and 34. Via 32 enables lead or capacitor plate 22 located above capacitive material 18 to communicate electrically with conductor 26. Conductor 26 is located on the upper surface of PCB 120. Conductor 26 may be a ground or shield conductor. Via 34 is filled with VVM 10, which contacts conductor 26 and capacitor plate 24.

The embedded capacitive material 18 and associated plates 22 and 24 may replace some, many and potentially all of the surface mounted capacitors 118 shown on the top surface of substrate 42 of PCB 120. Also, various traces 102 located on the top surface of PCB 120 that would otherwise lead to the replaced surface mounted capacitors 118 could also be embedded between substrates 42, 44 and 46. Because capacitive material 18 is embedded and not easily replaced, it is important to protect the material from the harmful effects of an ESD event. VVM 10 provides such protection. VVM 10 is likewise embedded and consumes no valuable external PCB space.

In an embodiment different areas of capacitive material 18 having different dielectric constants or properties are placed between substrates 42, 44 and 46. The different dielectric properties enable different circuits to employ different capacitances as desired. Likewise, capacitive material 16 can be applied in any desired shape, trace pattern and/or quantity as needed.

PCB 120 also includes an active laminate 75, which is described in more detail below. Generally, active laminate 75 includes a VVM layer 100 and a conductive foil 72. Active laminate 75 in an embodiment is produced independently and is applied to PCB 120 as needed. Active laminate 75 may also be prepared with a resistive layer 16, capacitve layer 18 or other type of layer having a desired electrical finction or property. In the illustrated embodiment, active laminate is prepared with a layer of resistive material 16. Resistive material 16 is applied to the VVM layer 100 of active laminate 75, on the opposite side of the VVM layer from conductive foil 72. Resistive material 16 is secured to insulative substrate 42 via lamination, compression, adhesion or other suitable process. Conductive foil 72 is secured to substrate 46 via lamination, compression, adhesion, any combination thereof or other suitable process.

As before, the embedded resistive material 16 of active laminate 75 may replace some, many and potentially all of the surface mounted resistors 116 and associated traces 102 shown on the top surface of substrate 42 of PCB 120. VVM layer 100 protects embedded resistive material 16 from the ESD event. VVM 100 is likewise embedded and consumes no valuable external PCB space.

In the illustrated embodiment, resistive material 16 is connected electrically to external component 104 through plated vias 114 formed in substrate 42. Conductive foil 72 can be etched to form traces as desired. Those traces may contact other embedded electrical materials and/or communicate with components located on the inner and/or outer surface of insulative substrate 46. Traces 102 may also be formed on the inside of outer substrates 42 and/or 46 and on the surfaces of middle substrate 44. Such interior traces 102 can contact VVM layer 100 (as shown), resistive material 16, capacitive material 18, and/or other internal electrical components as needed.

### Embedded Electrical Components and VVM

Referring now to FIGS. 5A and 5B, one application of the embedded VVM 10 of the present invention is illustrated. Node 12 is connected electrically to a lead or trace 22. Node 14 is connected electrically to a lead or trace 24. Nodes 12 and 14 are also connected electrically to resistive element or resistive material 16. Conductors 26 and 28 extend from nodes 12 and 14 in parallel with resistive material 16. As seen in FIG. 5A, a gap 30 is formed between conductors 26 and 28. As seen in FIG. 5B, VVM 10 is placed in gap 30 and connects electrically to conductors 26 and 28.

The application of FIGS. 5A and 5B may be characterized as a coplanar or X-Y application in which nodes 12 and 14, leads 22 and 24, conductors 26 and 28, gap 30 and VVM 10 are applied to or reside on a single substrate, for example, of a PCB. Gap 30 is formed on and VVM is applied to the same plane upon which the nodes, traces and conductors are formed. In an embodiment, the substrate is an internal substrate and thus nodes 12 and 14, leads 22 and 24, conductors 26 and 28, gap 30 and VVM 10 are embedded within the PCB.

Resistor 16 (for any of the embodiments described herein) can be provided in a device. Resistor 16 (for any of the embodiments described herein) can also be provided as a material, which may be applied to a substrate via a process such as a screen printing process, stencil printing process, pressurized application process and the like. A laminate resistive material 16 may be obtained from Rohm and Haas under the tradename Insite™ and provided in a sheet resistivity range of about 500 ohms/cm² to about 1000 ohms/cm².

VVM 10 (for any of the embodiments described in FIGS. 1 to 14) as discussed herein may be provided in a device. Alternatively, VVM 10 (for any of the embodiments described in FIGS. 1 to 14) may be provided in a printable or spreadable form. Various suitable VVM's are described in U.S. patent application Ser. No. 10/958,442, filed Oct. 5, 2004, entitled “Direct Application Variable Material, Devices Employing Same And Methods Of Manufacturing Such Devices,” each such VVM being expressly incorporated herein by reference.

Referring now to FIGS. 6A and 6B, another application of the embedded VVM 10 of the present invention is illustrated. Node 12 is connected electrically to a lead or trace 22. Node 14 is connected electrically to a lead or trace 24. Nodes 12 and 14 are also connected electrically to resistive element or resistive material 16. As seen in FIG. 6A, a gap 30 is formed between nodes 12 and 14. As seen in FIG. 6B, VVM 10 is placed in gap 30 and connects electrically to nodes 12 and 14.

The application of FIGS. 6A and 6B may be characterized as a coplanar application in which nodes 12 and 14, leads 22 and 24 and gap 30 are applied to or reside on a single substrate, for example, of a PCB. Gap 30 is formed on and VVM 10 is applied to the same plane upon which the nodes, traces and conductors are formed. In an embodiment, the substrate is an internal substrate and thus nodes 12 and 14, leads 22 and 24, gap 30 and VVM 10 are embedded within the PCB. In alternative embodiments, nodes 12 and 14, leads 22 and 24, gap 30 and VVM 10 are placed on the top or bottom of the PCB.

Referring now to FIGS. 7A and 7B, a further application of the embedded VVM 10 of the present invention is illustrated. Node 12 is connected electrically to a lead or trace 22. Node 14 is connected electrically to a lead or trace 24. Nodes 12 and 14 are also connected electrically to resistive element or resistive material 16. Conductors 26 and 28 extend from, and may be formed integrally with, nodes 12 and 14. As seen in FIG. 7A, a gap 30 is formed between conductors 26 and 28. As seen in FIG. 7B, VVM 10 is placed in gap 30 and connects electrically to conductors 26 and 28.

The application of FIGS. 7A and 7B may be characterized as a coplanar or X-Y application in which nodes 12 and 14, leads 22 and 24, conductors 26 and 28, gap 30 and VVM 10 are applied to or reside on a single substrate, for example, of a PCB. Gap 30 is generally formed on, and VVM is applied, to the same plane upon which the nodes, traces and conductors are formed. In an embodiment, the substrate is an internal substrate and thus nodes 12 and 14, leads 22 and 24, conductors 26 and 28, gap 30 and VVM 10 are embedded within the PCB.

Alternatively, node 12 may reside on a first substrate while node 14 resides on a second substrate to form a Z-direction application. Either of the substrates may be an internal substrate of a multilayer PCB. Here, VVM 10 is applied adjacent to resistive material 16, for example, between the substrates supporting nodes 12 and 14.

Referring now to FIG. 8, one embodiment of a multilayer PCB that employs the embedded components and VVM of the present invention is illustrated by assembly 40. Assembly 40 includes insulative substrates 42, 44 and 46. Insulative substrates 42, 44 and 46 (and any of the substrates described herein) may include any one or more type of rigid or semi-rigid substrate, such as, FR-4, woven or non-woven glass, PTFE and microfiber glass, ceramic, thermoset plastic, a polyimide, Kapton®, etc.

Middle substrate 44 includes or defines vias 32 and 34. Vias 32 and 34 enable leads or traces 22 and 24 located between substrates 44 and 46 to communicate electrically with conductors 26 and 28. Leads or traces 22 and 24 communicate electrically through resistive material 16. Conductors 26 and 28 are located between substrates 42 and 44. Conductors 26 and 28 and substrates 42 and 44 define a gap 30, which is filled VVM 10 in a coplanar or X-Y application. Traces 22 and 24 in an embodiment are integrated into a circuit, which may be embedded completely within assembly 40 or be connected electrically with a circuit located on the outside of one of the outer substrates 42 and 46.

Conductors 26 and 28 may be part of an embedded circuit protection network, which can include a plurality of areas of VVM 10 or one or more larger areas of VVM 10. One of conductors 26 and 28 may lead to a ground or shield. It should be appreciated that assembly 40 includes a parallel electrical circuit similar to those shown in FIGS. 5B, 6B and 7B. Assembly 40 may be or be part of a discrete device or be large enough to receive and support a plurality of surface-mount or through-hole electrical components. The configuration of assembly 40 may alternatively or additionally be used with an embedded capacitive material 18 or other type of electrical material or device.

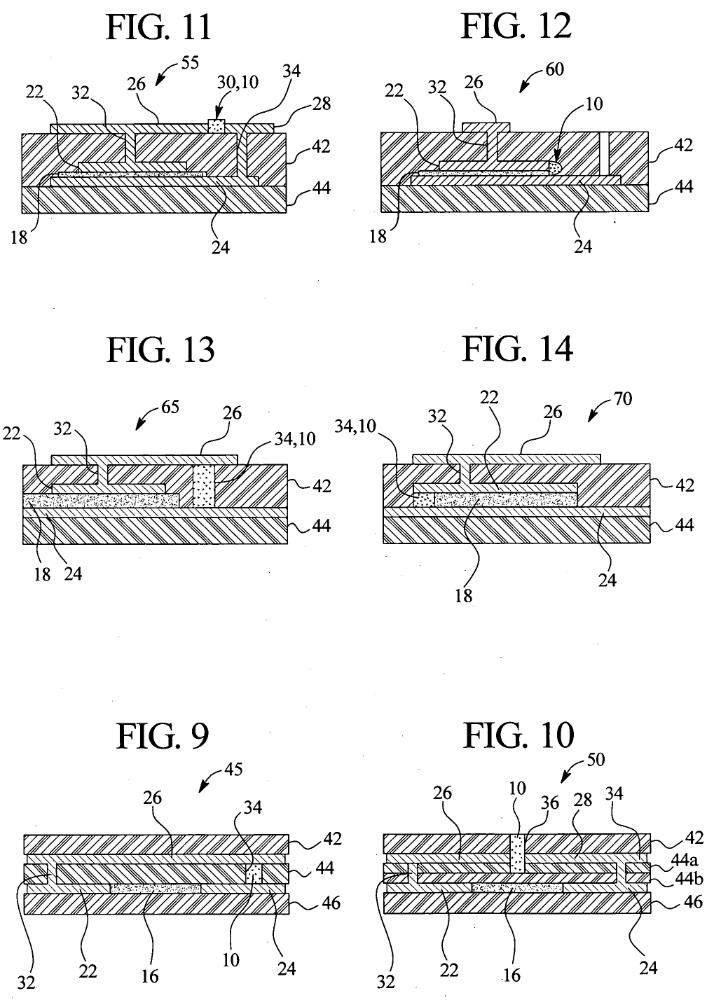

Referring now to FIG. 9, one embodiment of a multilayer PCB that employs the embedded components and VVM of the present invention is illustrated by assembly 45. Assembly 45 includes insulative substrates 42, 44 and 46. Middle substrate 44 includes or defines vias 32 and 34. Via 32 enables lead or trace 22 located between substrates 44 and 46 to communicate electrically with conductor 26. Conductor 26 is located between substrates 42 and 44, and in an embodiment is a ground or shield conductor. Conductor 26 may be part of an embedded circuit protection network, which can include a plurality of areas of VVM 10 or one or more larger areas of VVM 10.

Via 34 defines gap 30, which is filled VVM 10. Such configuration enables conductor 28 (shown above) to be eliminated. Traces 22 and 24 in an embodiment are integrated into a circuit, which may be embedded completely within assembly 45 or be connected electrically with a circuit located on the outside of one of the outer substrates 42 and 46.

It should be appreciated that assembly 45 includes a parallel electrical circuit similar to those shown above. Placing VVM 10 in via 34 yields a Z-direction application in which the width of the VVM gap is essentially the thickness of substrate 44. In any of the embodiments described herein, the VVM gap thickness is configured such that an ESD event appearing along either trace 22 or 24 is shunted properly away from the electrical component, such as resistor 16.

Assembly 45 may be or be part of a discrete device or be large enough to receive and support a plurality of surface-mount or through-hole electrical components. The configuration of assembly 45 may alternatively or additionally be used with an embedded capacitive material 18 or other type of electrical material or device.

Referring now to FIG. 10, one embodiment of a multilayer PCB that employs the embedded components and VVM of the present invention is illustrated by assembly 50. Assembly 50 includes outer insulative substrates 42 and 46 and a pair of inner substrates 44a and 44b. Traces 22 and 24 communicate electrically with resistor 16. Conductors 26 and 28 communicate electrically with VVM 10. Middle substrates 44a and 44b include or define vias 32 and 34. Vias 32 and 34 enable traces 22 and 24, located between substrates 44b and 46, to communicate electrically with conductors 26 and 28. Conductors 26 and 28 are located between substrates 42 and 44a.

Substrates 42, 44a and 44b include or define collectively a third via 36. Via 36 is filled VVM 10. VVM 10 may be loaded into assembly 50 from the outside of outer substrate 42. Vias 32 and 34 can be metallized after substrates 44a and 44b are applied to substrate 46, traces 22 and 24 and resistive material 16. Vias 32 and 34 in an embodiment are metallized during the same process in which conductors 26 and 28 are defined onto substrate 44a.

Traces 22 and 24 in an embodiment are integrated into a circuit, which may be embedded completely within assembly 50 or connected electrically with a circuit located on the outside of one of the outer substrates 42 and 46. Conductors 26 and 28 in turn may be part of an embedded circuit protection network, which can include a plurality of areas of VVM 10 or one or more larger areas of VVM 10. One of conductors 26 and 28 may lead to a ground or shield.

It should be appreciated that assembly 50 includes a parallel electrical circuit similar to those shown above. Placing VVM 10 in third via 36 yields an X-Y application in which the width of the VVM gap is essentially the diameter or cross-sectional distance of via 36. As before, the VVM gap thickness is configured such that an ESD event appearing along either trace 22 or 24 is shunted properly away from the embedded electrical component, such as resistor 16.

Assembly 50 may be or be part of a discrete device or be large enough to receive and support a plurality of surface-mount or through-hole electrical components. The configuration of assembly 50 may alternatively or additionally be used with an embedded capacitive material 18 or other type of electrical material or device

Referring now to FIGS. 11 to 14, various embodiments for embedding a capacitor or capacitive material 18 are illustrated. As before, each of the embodiments in FIGS. 11 to 14 may alternatively or additionally employ an embedded resistive material or other type of electrical component or material. Capacitor or dielectric 18 (for any of the embodiments described herein) can be provided in a device. Capacitor or dielectric 18 (for any of the embodiments described herein) can also be provided as a material, which may be applied to a capacitor plate and/or substrate via a process such as a screen printing process, stencil printing process, pressurized application process and the like. A laminate capacitor dielectric material 18 may be obtained from Rohm and Haas under the tradename Insite™, which is provided in a rating range of up to 200 nF/square cm.

In FIG. 11, one embodiment of a multilayer PCB that employs the embedded components and VVM of the present invention is illustrated by assembly 55. Assembly 55 includes two insulative substrates 42 and 44. Upper substrate 42 includes or defines vias 32 and 34. Via 32 enables lead or capacitor plate 22 located above capacitive material 18 to communicate electrically with conductor 26. Conductor 26 is located on the outside of upper substrate 42. Via 34 enables trace or capacitor plate 24 located below capacitive material 18 to communicate electrically with conductor 28. Conductor 28 is located on the outside of upper substrate 42. In the illustrated embodiment, the circuit protection circuit is located at least partially on the outside of assembly 55, while a main electrical circuit including capacitor plates 22 and 24 and capacitor 18 is embedded at least partially within assembly 55. Assembly 55 emphasizes that any portion or all of the circuit protection circuit and/or the main electrical circuit may be located on an outside surface of the PCB.

Conductors 26 and 28 define gap 30, which is filled VVM 10. One of conductors 26 and 28 may be a ground or shield conductor. That ground or shield conductor may be part of an embedded circuit protection network, which can include a plurality of areas of VVM 10 or one or more larger areas of VVM 10.

It should be appreciated that assembly 55 includes a parallel electrical circuit similar to those shown above. Placing VVM 10 in gap 30 yields an X-Y direction application in which the width of the VVM gap is the distance between the ends of conductors 26 and 28. As before, the VVM gap thickness is configured such that an ESD event appearing along either capacitor plate 22 or 24 is shunted properly away from the electrical component, such as capacitor 18.

In FIGS. 11 to 14, traces 22 and 24 are or act as capacitor plates, which run in parallel contact with capacitor dielectric material 18. On the other hand as shown above, traces 22 and 24 contact the ends of resistor material 16 in one embodiment. Alternatively, traces 22 and 24 may contact resistive material 16 in a parallel or coplanar relationship.

In FIG. 11, in an embodiment, capacitor plates 22 and 24 and dielectric material 18 are screen or stencil printed or laminated onto lower substrate 44. Afterwards, upper substrate 42 is applied to the capacitive sub-assembly. Vias 32 and 34 may be metallized in the same process that applies conductors 26 and 28 to the outside of upper substrate 42. VVM 10 is then applied to gap 30 as a device or via any of the methods described in U.S. patent application Ser. No. 10/958,442, filed Oct. 5, 2004, entitled “Direct Application Variable Material, Devices Employing Same And Methods Of Manufacturing Such Devices,” each method being expressly incorporated by reference for each of the embodiments disclosed herein.

Assembly 55 may be or be part of a discrete device or be large enough to receive and support a plurality of surface-mount or through-hole electrical components. As mentioned above, the configuration of assembly 55 may alternatively or additionally be used with an embedded resistive material 16 or other type of electrical material or device.

In FIG. 12, another embodiment of a multilayer PCB that employs the embedded components and VVM of the present invention is illustrated by assembly 60. Assembly 60 includes two insulative substrates 42 and 44. Upper substrate 42 includes or defines a via 32. Via 32 enables lead or capacitor plate 22 located above capacitive material 18 to communicate electrically with conductor 26. Conductor 26 is located on the outside of upper substrate 42. Conductor 26 may be a ground or shield conductor. That ground or shield conductor may be part of an embedded circuit protection network, which can include a plurality of areas of VVM 10 or one or more larger areas of VVM 10.

VVM 10 is applied onto capacitor plate 24 so that it contacts the edge of capacitor plate 22 and dielectric material 18. The VVM gap distance here is essentially the Z-direction thickness of dielectric material 18. As before, the VVM gap thickness is configured such that an ESD event appearing along either capacitor plate 22 or 24 is shunted properly away from the electrical component, such as capacitor 18. The configuration of assembly 60 eliminates conductor 28 and second via 34 compared to assembly 55. VVM 10 in assembly 60 is embedded, whereas VVM 10 of assembly 55 is surface applied. It should be appreciated that assembly 60 includes a parallel electrical circuit similar to those shown above.

In FIG. 12, in an embodiment, capacitor plates 22 and 24, dielectric material 18 and VVM 10 are screen or stencil printed or otherwise applied onto lower substrate 44. Afterwards, upper substrate 42 is applied to the capacitive sub-assembly. Via 32 may be metallized in the same process that applies conductor 26 to the outside of upper substrate 42.

Assembly 60 may be or be part of a discrete device or be large enough to receive and support a plurality of surface-mount or through-hole electrical components. As mentioned above, the configuration of assembly 60 may alternatively or additionally be used with an embedded resistive material 16 or other type of electrical material or device.

In FIG. 13, another embodiment of a multilayer PCB that employs the embedded components and VVM of the present invention is illustrated by assembly 65. Assembly 65 includes two insulative substrates 42 and 44. Upper substrate 42 includes or defines vias 32 and 34. Via 32 enables lead or capacitor plate 22 located above capacitive material 18 to communicate electrically with conductor 26. Conductor 26 is located on the outside of upper substrate 42. Conductor 26 may be a ground or shield conductor. That ground or shield conductor may be part of an embedded circuit protection network, which can include a plurality of areas of VVM 10 or one or more larger areas of VVM 10.

Via 34 is filled with VVM, which contacts conductor 26 and capacitor plate 24. The VVM gap distance here is essentially the Z-direction thickness of substrate 42. As before, the VVM gap thickness is configured such that an ESD event appearing along either capacitor plate 22 or 24 is shunted properly away from the electrical component, such as capacitor 18. The configuration of assembly 65 eliminates conductor 28 compared to assembly 55. VVM 10 in assembly 65 is embedded, like that of assembly 60. It should be appreciated that assembly 65 includes a parallel electrical circuit similar to those shown above.

In FIG. 13, in an embodiment, capacitor plates 22 and 24, dielectric material 18 and are screen or stencil printed or otherwise applied onto lower substrate 44. Afterwards, upper substrate 42 is applied to the capacitive sub-assembly. VVM 10 is placed in via 34 via screen printing, stencil printing, pressurized application or other suitable method. Via 32 may be metallized in the same process that applies conductor 26 to the outside of upper substrate 42.

Assembly 65 may be or be part of a discrete device or be large enough to receive and support a plurality of surface-mount or through-hole electrical components. As mentioned above, the configuration of assembly 65 may alternatively or additionally be used with an embedded resistive material 16 or other type of electrical material or device.

In FIG. 14, a further embodiment of a multilayer PCB that employs the embedded components and VVM of the present invention is illustrated by assembly 70. Assembly 70 includes two insulative substrates 42 and 44. Upper substrate 42 includes or defines a via 32. Via 32 enables lead or capacitor plate 22 located above capacitive material 18 to communicate electrically with conductor 26. Conductor 26 is located on the outside of upper substrate 42. Conductor 26 may be a ground or shield conductor. That ground or shield conductor may be part of an embedded circuit protection network, which can include a plurality of areas of VVM 10 or one or more larger areas of VVM 10.

VVM 10 is applied into via 34 so that it contacts capacitor plate 24 and the edge of dielectric material 18. Unlike assembly 60, upper capacitor plate 22 extends over the top of VVM 10 in assembly 70, which may provide improved electrical contact. The VVM gap distance again is essentially the Z-direction thickness of dielectric material 18. As before, the VVM gap thickness is configured such that an ESD event appearing along either capacitor plate 22 or 24 is shunted properly away from the electrical component, such as capacitor 18. The configuration of assembly 70 eliminates conductor 28 compared to assembly 55. VVM 10 in assembly 70 is embedded, as is VVM 10 of assemblies 60 and 65. It should be appreciated that assembly 70 includes a parallel electrical circuit similar to those shown above.

In FIG. 14, in an embodiment, capacitor plates 22 and 24, dielectric material 18 and VVM 10 are screen or stencil printed or otherwise applied onto lower substrate 44. Here, upper capacitor plate 22 may be applied to VVM 10 and dielectric material 18 (in FIG. 12, on the other hand, VVM 10 may be applied after upper and lower plates 22 and 24 are applied to substrate 44). Afterwards, upper substrate 42 is applied to the capacitive sub-assembly. Via 32 may be metallized in the same process that applies conductor 26 to the outside of upper substrate 42.

Assembly 70 may be or be part of a discrete device or be large enough to receive and support a plurality of surface-mount or through-hole electrical components. As mentioned above, the configuration of assembly 70 may alternatively or additionally be used with an embedded resistive material 16 or other type of electrical material or device.

### Active Laminate

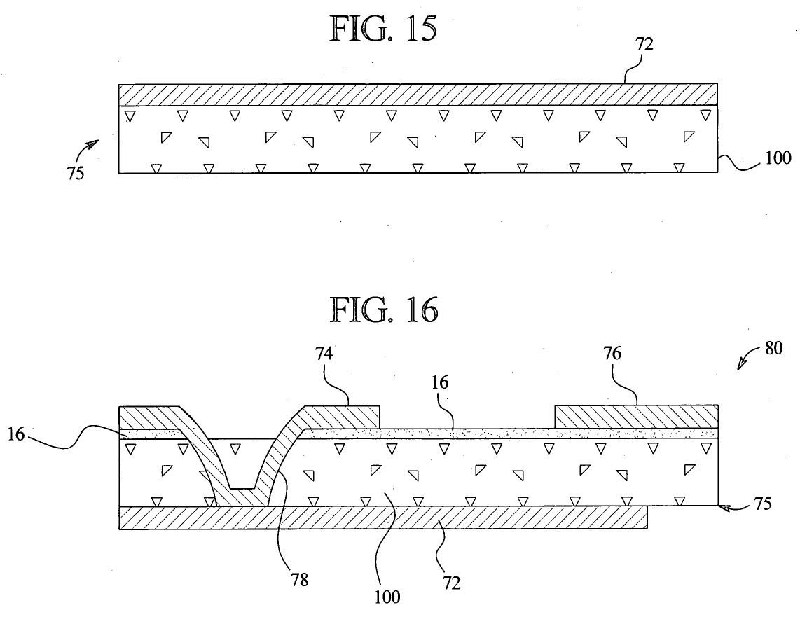

Referring now to FIGS. 15 to 21, various embodiments for the active laminate or active substrate, RCF or RCC (referred to from here collectively as active laminate for convenience) are illustrated. The teachings of FIGS. 1 to 4 are equally applicable to the active laminate embodiments in FIGS. 15 to 21. Moreover, the embodiments in FIGS. 15 to 21 are similar to the ones described in FIGS. 5A to 14 in that both include the location of VVM and electrical components within or inside a PCB.

FIG. 15 illustrates the primary difference between the active laminate 75 and the embodiments employing VVM 10 described above. Active laminate 75 includes a VVM layer 100, which is applied to or coated onto a conductive foil 72, such as a copper foil. In an alternative embodiment, conductive foil 72 is etched or printed onto VVM layer 100. In an embodiment, conductive foil 72 is from about 5 microns to about 70 microns thick and VVM layer 100 is from about 70 microns to about 100 microns thick. Other thicknesses for each may be employed VVM layer 100 is loaded with various types of conductive, semi-conductive, insulative and other VVM particles. The insulative binder of VVM layer 100 in an embodiment is applied to conductive foil 72 in a semi-cured or pre-preg condition. The semi-cured VVM layer 100 may then be fully cured to a rigid or semi-rigid substrate, such as a rigid FR-4 substrate, or a flexible polymide, e.g., Kapton™ tape. The final curing is performed in one embodiment via a pressure-burner, which applies pressure and heat to secure the VVM layer 100 of active laminate 75 to the rigid or semi-rigid, e.g., FR-4 board. Or, a final curing process is performed that cures the VVM layer 100 of active laminate 75 to a layer of, e.g., resistive material 16 or capacitive material 18. The final assembly, such as one shown figuratively in FIG. 4, can employ the active laminate 75 (with or without the layer of resistive material 16 or capacitive material 18) with one or more rigid or semi-rigid substrates to support surface-mounted components and circuit traces.

A VVM substrate is disclosed in U.S. patent application Ser. No. 09/976,964 (the '964 Application), filed Oct. 11, 2001, entitled “Voltage Variable Substrate Material,” the entire contents of which are incorporated herein by reference. The VVM substrate in that application is self-supporting, rigid or semi-rigid and capable of receiving and supporting electrical components (including printable electrical materials) and additional conductive and insulative layers, traces, pads, etc. The VVM substrate of the '964 Application includes an insulative binder that is impregnated with fibers or cross-linking members. Such cross-linking members add rigidity to the binder and the resulting substrate. WM layer 100 in the present invention may not include cross-linking members, enabling the VVM binder to hold the, e.g., conductive, semi-conductive or insulative particles and still be spread or applied readily to the conductive foil 72. The WM binder is also structured to remain in a semi-cured state until the active laminate 75 is applied to a carrier PCB.

It is contemplated that the active laminate 75 will be provided in a roll or in sheets. The active laminate 75 in an embodiment is supplied to a board assembler, who cuts or sections the active laminate to an appropriate size and shape and applies the cut active laminate shape to the carrier PCB, which can be rigid or semi-rigid. The assembler may then place surface-mounted components on the resulting assembly or ship the assembly to an end user for final assembly.

Referring now to FIG. 16, in one embodiment an electrical component layer is applied to VVM layer 100. Here, a layer of resistive material 16 is applied to VVM layer 100 via lamination, compression, adhesion, any combination thereof or other suitable process. In FIG. 16, an assembly 80 that employs the active laminate 75 and a layer of resistive material 16 is illustrated. Resistive material 16, which is the same material 16 described above in one embodiment, is applied to the opposite side of VVM layer 100 from conductive foil 72. Conductive areas 74 and 76 are then applied to resistive material 16. Conductive areas 74 and 76 may be conductive traces, conductive pads, conductive foils, etc. In an embodiment, a conductive layer is applied over a large area on resistive material 16. The conductive material is then etched away in areas where it is not needed.

A via 78 is formed through VVM 100 and resistive material 16. Conductive area 74 extends through via 78 and contacts conductive foil 72. Conductive area 76 is connected by a resistive material to conductive area 74 or conductive foil 72 under normal conditions because VVM layer 100 is normally in a state of high impedance. Upon an ESD event occurring along conductive area 76, however, VVM layer 100 switches to a low impedance state and allows the ESD energy to be shunted across VVM layer 100 to conductive foil 72. Conductive foil 72 in an embodiment is a ground or shield conductor.

The thickness of VVM layer 100 forms the VVM gap. The VVM gap distance is a Z-direction gap, which extends perpendicular to conductive area 76 and conductive foil 72. As before, the VVM gap thickness is configured such that an ESD event appearing along conductive area 76 is shunted properly away from an electrical component, such as resistor material 16. VVM layer 100 and resistor 16 are internal or embedded, saving outer board space on assembly 80 for other electrical components. It should be appreciated that assembly 80 includes a parallel electrical circuit similar to those shown above.

VVM layer 100 and resistor material 16 extend so that the substrate and resistor material may be used repeatedly as necessary at different areas of assembly 80. Conductive foil 72 provides a ground or shield plane that grounds surface-mount and through-hole components in addition to resistor material 16.

Assembly 80 may be or be part of a discrete device or be large enough to receive and support a plurality of surface-mount or through-hole electrical components. The configuration of assembly 80 may alternatively or additionally be used with an embedded capacitive material 18 or other type of electrical material or device.

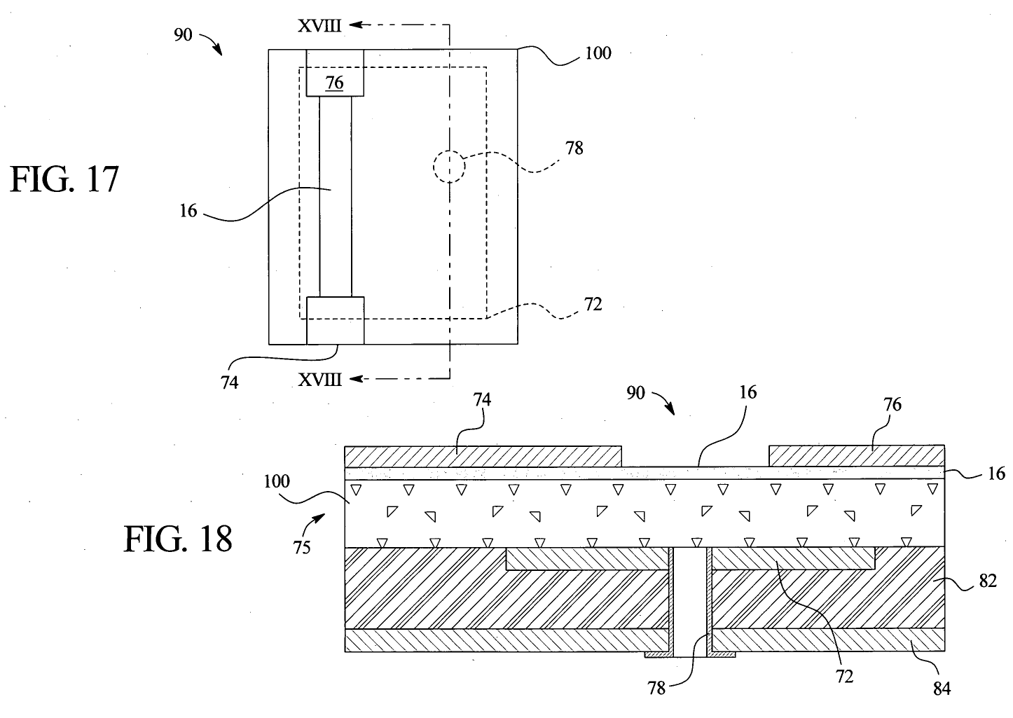

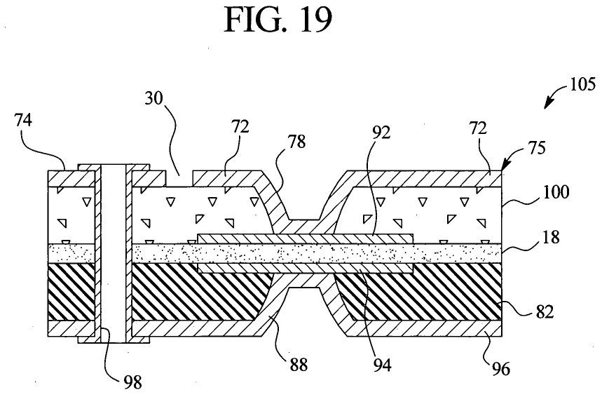

Referring now to FIGS. 17 and 18, another embodiment of a PCB that employs the active laminate 75 and embedded electrical components of the present invention is illustrated by assembly 90. Resistive material 16, which is the same material 16 described above in one embodiment, is applied to the opposite side of VVM layer 100 from conductive foil 72. Conductive areas 74 and 76 are then applied to resistive material 16 via any of the methods described herein. An insulative layer 82 is applied beneath VVM layer 100 and conductive foil 72. A ground plane 84 is then applied beneath insulative layer 82. A via 78 is formed through conductive foil 72, insulative layer 82 and ground plane 84. Via 78 is plated so that conductive foil 72 communicates electrically with ground plane 84.

Conductive area 74 and conductive area 76 do not normally communicate electrically with each other or conductive foil 72 because VVM layer 100 is normally in a state of high impedance. Upon an ESD event occurring along conductive area 74 or 76, however, VVM layer 100 switches to a low impedance state and allows the ESD energy to be shunted across VVM layer 100 to conductive foil 72, plated via 78 and ground or shield plane 84.

The thickness of VVM layer 100 again forms the VVM gap. The VVM gap distance is a Z-direction gap, which extends perpendicular to the coplanar conductive areas 74 and 76 and conductive foil 72. As before, the VVM gap thickness is configured such that an ESD event appearing along conductive area 74 or area 76 is shunted properly away from an electrical component, such as resistor material 16. VVM layer 100 and resistor 16 are internal or embedded, saving outer board space on assembly 90 for other electrical components or reducing the size needed for assembly 90. It should be appreciated that assembly 90 includes a parallel electrical circuit similar to those shown above.

VVM layer 100 and resistor material 16 extend so that the substrate and resistor material may used repeatedly as necessary at different areas of assembly 90. Assembly 90 may be or be part of a discrete device or be large enough to receive and support a plurality of surface-mount or through-hole electrical components. Conductive layer 84 provides a ground or shield plane that grounds surface-mount and through-hole components in addition to resistor material 16. The configuration of assembly 90 may alternatively or additionally be used with an embedded capacitive material 18 or other type of electrical material or device.

In an embodiment, conductive foil 72, insulative layer 82 and ground plane 84 are formed as a sub-assembly. Via 78 is then formed through the sub-assembly. Via 78 as well as any of the vias described herein may be formed by a mechanical, laser drilling or etching process. The subassembly with via 78 is then combined with VVM layer 100, which may or may not include resistor material 16 and/or conductive areas 74 and 76. Any of resistor material 16 and conductive areas 74 and 76 may be applied after the sub-assembly and substrate 75 are combined. Via 78 in an embodiment is metallized in the same process that applies ground plane 84 to insulative layer 82.

FIG. 17 shows a single resistor 16 and conductive area 74, 76 assembly. Assembly 90 alternatively provides multiple ones of those assemblies or others including a different type of electrical component.

Referring now to FIG. 19, one embodiment of a PCB that employs the active laminate 75 and an embedded capacitor of the present invention is illustrated by assembly 105. Here, capacitive material 18, which is the same material 18 described above in one embodiment, is applied to the opposite side of VVM layer 100 from conductive foil 72. The layer of capacitive material 18 is applied to VVM layer 100 via lamination, compression, any combination thereof adhesion or other suitable process.

Capacitor plates 92 and 94 are located on both sides of capacitive material 18 via any of the methods described herein. Capacitor plate 92 is located between VVM layer 100 and capacitive material 18. An insulative layer 82 is applied beneath capacitive material 18 and capacitor plate 94. A lower conductive layer 96 is located on the opposite side of insulative layer 82 from capacitive material 18. Either conductive foil 72 or lower conductive layer 96 may be a ground or shield plane.

Via 78 is formed through VVM layer 100 and is plated so that conductive foil 72 connects electrically with capacitor plate 92, which contacts capacitive material 18. Via 88 is formed through substrate 82 and is plated so that conductive layer 96 connects electrically with capacitor plate 94, which contacts capacitive material 18. Via 98 is formed through a separate upper conductive layer 74, VVM layer 100, capacitive material 18, substrate 82 and lower conductive layer 96. Via 98 is plated so that conductive layer 74 connects electrically with lower conductive layer 96. A gap 30 resides between conductive foil 72 and conductive layer 74.

Conductive layers 72 and 74 do not normally communicate electrically with one another because VVM layer 100 is normally in a state of high impedance. Upon an ESD event occurring along conductive area 72 (or capacitor plate 92), however, VVM layer 100 switches to a low impedance state and allows the ESD energy to be shunted across VVM layer 100 and gap 30 to conductive layer 74. Plated via 98 enables the shunted energy to dissipate to lower conductive layer 96, which may be a ground or shield plane.

As before, the width of VVM gap 30 is configured such that an ESD event appearing along conductive area 72 is shunted properly away from an electrical component, such as dielectric material 18. Gap 30 provides an X-Y application of VVM layer, wherein the width of the gap runs in a parallel direction to the plane of the conductive areas 72 and 74. Alternatively, the thickness of VVM layer 100 forms the VVM gap. In such case, the VVM gap distance is a Z-direction gap, which extends perpendicular to the coplanar conductive areas 72 and 74.

VVM layer 100 and dielectric material 18 are internal or embedded, saving outer board space on assembly 105 for other electrical components or reducing the size needed for assembly 105. It should be appreciated that assembly 105 includes a parallel electrical circuit similar to those shown above.

VVM layer 100 and capacitor material 18 extend so that the substrate and capacitor material may used repeatedly as necessary at different areas of assembly 105. Assembly 105 may be or be part of a discrete device or be large enough to receive and support a plurality of surface-mount or through-hole electrical components. The configuration of assembly 105 may alternatively or additionally be used with an embedded resistive material 16 or other type of electrical material or device.

In an embodiment, layer 100 is formed with via 78. Conductive areas 72 and 74 are applied to one side of VVM layer 100, while capacitor plate 92 is applied to the other side of VVM layer 100. Insulative substrate 82 is formed with via 88. Conductive area is applied to one side of insulative substrate 82, while capacitor plate 94 is applied to the other side of insulative substrate 82. Dielectric material 18 is applied to one of (i) VVM layer 100 and capacitor plate 92 or (ii) insulative substrate 82 capacitor plate 94. The VVM layer 100 sub-assembly is combined with the insulative substrate 82 sub-assembly. Via 98 is then formed through the combined assembly and separately plated in one embodiment. In another embodiment, via 98 is plated in the same process that applies at least one of conductive areas 72, 74 and 96.

In a further alternative embodiment, insulative substrate 82 is replaced with a second VVM layer 100 (VVM layer and conductive foil 96 forming a second active laminate 75). In such case, a second gap may be placed between foil 96 and plated via 98. Upon an ESD event, the surge energy is shunted away from dielectric 18, through the second VVM layer 100 to plated via 98.

In yet a further alternative embodiment, via 98 runs to an internal ground plane. Here, via 98 could be isolated from one or both of top conductive layer 92 and bottom conductive layer 96.

Referring now to FIGS. 20 and 21, another embodiment of a PCB that employs the active laminate 75 in combination with a plurality of data lines 102 (referring collectively to data lines 102a to 102h, etc.) is illustrated by assembly 110. Conductive data lines or traces 102 are applied to VVM layer 100, on the opposite side from conductive foil 72 of active laminate 75. An electrical component 103 (shown in phantom) may be connected electrically to one or more of traces 102.

An insulative layer 82 is applied beneath VVM layer 100 and conductive foil 72. A ground plane 84 is then applied beneath insulative layer 82. A via 78 is formed through VVM layer 100, conductive foil 72, insulative layer 82 and ground plane 84. Via 78 is plated so that conductive foil 72 communicates electrically with ground plane 84. In an embodiment, via 78 is located beneath VVM layer 100 and connects electrically to conductive foil 72 and ground plane 84.

Data lines or traces 102 and component 103 do not normally communicate electrically with conductive foil 72 or plated via 78 because VVM layer 100 is normally in a state of high impedance. Upon an ESD event occurring along any one or more of data lines 102, however, VVM layer 100 switches to a low impedance state and allows the ESD energy to be shunted across VVM layer 100 to conductive foil 72, plated via 78 and ground or shield plane 84, protecting traces 102 and component 103.

The thickness of VVM layer 100 again forms the VVM gap. The VVM gap distance is a Z-direction gap, which extends perpendicular to the coplanar conductive traces or data lines 102. As before, the VVM gap thickness is configured such that an ESD event appearing along any of data lines 102 is shunted properly away from each of the data lines. Here, the thickness of the gap or VVM layer 100 should be less than a distance X between any two of the data lines. Such configuration ensures that a transient threat along one of the data lines travels the path of least resistance through VVM layer from the overloaded data line to conductive plane 72 instead of to an adjacent data line.

VVM layer 100 is internal or embedded, saving outer board space on assembly 90 for other electrical components or reducing the size needed for assembly 110. It should be appreciated that assembly 90 includes a parallel electrical circuit similar to those shown above.

VVM layer extends so that the substrate as illustrated may used repeatedly as necessary for a plurality of different data lines 102. Assembly 110 may be or be part of a discrete device or be large enough to receive and support a plurality of surface-mount or through-hole electrical components. Conductive layer 84 provides a ground or shield plane that grounds the surface-mounted data lines in addition to the embedded components 16 and or 18 shown above.

In an embodiment, VVM layer 100, conductive foil 72, insulative layer 82 and ground plane 84 are formed as an assembly. Via 78 is then formed through the assembly. Via 78 in an embodiment is metallized in the same process that applies ground plane 84 to insulative layer 82.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A voltage variable material (“VVM”) structure comprising:
first and second insulating layers;
an electrical component placed between the first and second insulating layers;
first and second conductors in electrical communication with the electrical component, the conductors extending between the first and second insulating layers;
a gap formed between the first and second conductors; and
a quantity of VVM placed across the gap so as to be in electrical communication with the first and second electrodes, the VVM operating to provide protection upon an occurrence of an electrostatic discharge event.

2. The VVM structure of claim 1, wherein the electrical component is of at least one type selected from the group consisting of: a resistor, a capacitor, an inductor, a transformer, a semiconductive device, an insulator, a conductor, an integrated circuit, and being constructed as a film.

3. The VVM structure of claim 1, wherein the insulating material is of a type selected from the group consisting of: FR-4, epoxy, ceramic, glass, a polymer and any combination thereof.

4. The VVM structure of claim 1, wherein the electrical component separates: (i) the first and second conductors to form the gap, the VVM placed across the gap; or (ii) the first and second conductors to form the gap, the VVM placed across and in a via formed in one of the first and second insulating layers.

5. The VVM structure of claim 1, wherein a via is formed in an insulating material, the via forming the gap, the VVM placed across and in the gap.

6. The VMM structure of claim 5, wherein the insulating material is one of the first and second insulating layers.

7. The VVM structure of claim 1, wherein the VVM is placed across and in the gap, filling at least a portion of the gap.

8. The VVM structure of claim 1, wherein at least one of the first or second insulating layers has a surface area greater than one square inch.

9. The VVM structure of claim 1, which includes a third insulating layer located between the first and second insulating layers, at least a portion of the first conductor residing between the first and third insulating layers, and at least a portion of the second conductor residing between the second and third insulating layers.

10. The VVM structure of claim 9, wherein (i) the third insulating layer defines a via, the VVM is placed across and in the via; or (ii) the first conductor extends between the second and third insulating layers, the electrical component placed in electrical communication with the first and second conductors at a location between the second and third insulating layers.

11. The VVM structure of claim 1, wherein the gap is a via defined by the first insulating layer, the via extending through an external surface of the first insulating layer, the VVM placed across and filling at least a portion of the via.

12. The VVM structure of claim 11, wherein one of the first and second conductors extends along the external surface to communicate electrically with the VVM.

13. The VVM structure of claim 1, wherein at least the first electrode extends through one of the first and second insulating layers and extends along an outer surface of the first or second insulating layer.

14. The VVM structure of claim 13, wherein (i) the first electrode communicates electrically with the VVM along the external surface; or (ii) the VVM is placed between the first and second conductors.

15. A voltage variable material (“VVM”) structure comprising:
first and second insulating layers;
an electrical component placed between the first and second insulating layers;
first and second conductors in electrical communication with the electrical component, the conductors extending between the first and second insulating layers; and
a quantity of the VVM contacting the first and second conductors and communicating electrically in parallel with the electrical component, the VVM operating to provide protection upon an occurrence of an electrical discharge event.

16. The VVM structure of claim 15, wherein the VVM is placed between the first and second conductors.

17. The VVM structure of claim 15, which includes a gap formed by the first and second conductors, the VVM placed across and in the gap.

18. A voltage variable material (“VVM”) structure comprising:
first and second insulating layers;
an electrical component placed between the first and second insulating layers;
first and second conductors in electrical communication with the electrical component, the first conductor extending through the first insulating layer to communicate with the electrical component; and
a quantity of the VVM contacting the first and second conductors and communicating electrically in parallel with the electrical component, the VVM operating to provide protection upon an occurrence of an electrical discharge event.

19. The VVM structure of claim 18, wherein the second conductor extends through one of the first and second insulating layers.

20. The VVM structure of claim 18, wherein at least one of the first and second conductors extends: (i) through one of the insulating layers or (ii) along an external surface of one of the insulating layers.

21. The VVM structure of claim 18, which includes a third insulating layer, the first conductor extending between the first and third insulating layers.

22. The VVM structure of claim 21, which includes a fourth insulating layer, the second conductor extending between the second and fourth insulating layers.

23. The VVM structure of claim 21, wherein at least one of the conductors extends: (i) between the first and second insulating layers; (ii) between the first and third and first and second insulating layers; or (iii) along an external surface of one of the first and second insulators.

24. A voltage variable material (“VVM”) structure comprising:
a layer having a thickness, the layer including VVM, the VVM providing protection from an electrostatic discharge event;
a material contacting at least a portion of a surface of the layer, the material performing an electrical function;
a first conductor placed in an electrical communication with the material;
a second conductor placed in electrical communication with the material; and
which includes a gap between the first and second conductors, the thickness of the layer being less than the gap between the first and second conductors.

25. The VVM structure of claim 24, wherein the electrical function is a resistive function, a capacitive function, an inductive function, a semi-conductive function, an insulative function, an integrated circuit function or a capacitive function.

26. The VVM structure of claim 24, wherein the surface is a first surface and which includes a second surface of the VVM layer, a conductive layer contacting at least a portion of the second surface of the VVM layer, and wherein the first conductor is in electrical communication with the conductive layer.

27. The VVM structure of claim 26, wherein the first conductor communicates electrically with the conductive layer through a via formed in the VVM layer.

28. The VVM structure of claim 26, which includes an insulating layer placed in contact with at least a portion of the conductive layer.

29. The VVM structure of claim 28, wherein the insulating layer is also in contact with the laminate.

30. The VVM structure of claim 28, which includes a ground plane contacting the insulating layer, the ground plane in electrical communication with the VVM layer.

31. The VVM structure of claim 30, wherein the ground plane communicates with the VVM layer through a via formed in the insulating layer.

32. The VVM structure of claim 24, wherein the VVM layer has a surface area greater than one square inch.

33. The VVM structure of claim 24, wherein the VVM layer is a first VVM layer and which includes a second VVM layer, the first VVM layer contacting a first side of the material, the second VVM layer contacting at least a portion of a second side of the material.

34. The VVM structure of claim 33, wherein at least one of the first and second conductors communicates electrically with the material through a via formed in one of the first and second VVM layers.

35. A voltage variable material (“VVM”) structure comprising:
a material performing an electrical function;
a VVM layer, the VVM layer providing protection from an electrostatic discharge event, at least a portion of the VVM layer placed in contact with a first side of the material; and
a conductive layer, at least a portion of the conductive layer placed in electrical contact with a second side of the material.

36. The VVM structure of claim 35, which includes an at least semi-rigid layer, at least a portion of the at least semi-rigid layer placed in contact with the VVM layer or the conductive layer.

37. The VVM material of claim 36, which includes a first conductor placed in contact with the VVM layer and a second conductor placed in contact with the at least semi-rigid layer, one of the first and second conductors being a ground/shield conductor.

38. The VVM structure of claim 35, wherein the electrical function is a resistive function, a capacitive function, an inductive function, a semi-conductive function, an insulative function, an integrated circuit function or a capacitive function.

39. The VVM material of claim 35, which includes a via formed through the VVM layer, the via enabling electrical communication between conductors located on opposite sides of the VVM layer.

40. A voltage variable (“VVM”) structure comprising:
a conductive layer; and
a VVM layer, the VVM layer applied to the conductive layer in a semi-cured state so that the VVM layer may be secured when needed to a supporting substrate.

41. A product produced via the VVM structure of claim 40, the product including at least one of: (i) a plurality of electrical traces formed from the conductive layer and (ii) an electrical component connected electrically to the conductive layer, the VVM in the VVM layer providing protection to at least one of: (i) the traces and (ii) the electrical component upon an electrostatic discharge event.
